(19) United States
(12) Patent Application Publication
(10) Pub. No.: US 2008/0286586 A1
(43) Pub. Date: Nov. 20, 2008

(54) Polypropylene Modification for Improved Adhesion of Polypropylene-Based Multilayer Packaging Film Structure to Vaccum Deposited Aluminum

(75) Inventor: Christian Leboeuf, Kingston (CA)

Correspondence Address: Bromels Marilyn H;E I Du Pont De Nemours And Company, Legal Patent Records Center, 4417 Lancaster Pike, Wilmington, DE, 19805, US

(73) Assignee: E. I. DuPont De Nemours and Company, Wilmington, DE (US)

(21) Appl. No.: 10/585,185

(22) PCT Filed: Jan. 7, 2005
(86) PCT No.: PCT/CA05/00019

§ 371 Date: Aug. 3, 2006

Related U.S. Application Data
(60) Provisional application No. 60/535,384, filed on Jan. 9, 2004.

(51) Int. Cl. B32B 27/06; B05D 3/00; B05D 1/00; C08L 23/26

(52) U.S. Cl. 428/461; 427/322; 427/296; 525/240

(57) ABSTRACT

There is provided a metallizable alkene or olefin polymer composition. The composition results from the blending of a modifier with an alkene or olefin polymer composition. The modifier is selected from the group consisting of: a maleic anhydride grafted ethylene copolymer, an ethylene copolymer containing acid monomers and/or ester monomers, an acid-grafted propylene copolymer, and a maleic anhydride grafted blend of a propylene copolymer with an ethylene copolymer. The resultant polymeric composition adheres surprisingly well to metal films and particularly well to aluminum film. The resultant composition also has unexpectedly favourable rheology properties making the composition efficient to use in co-extrusion processes. Also provided is a method of preparing the polymer compositions.

### FIELD OF THE INVENTION

The present invention relates to modified propylene polymers that form metallizable films having improved adhesion to metals such as aluminum, particularly for the production of barrier food wraps requiring adhesion of a metallizable film to a metal layer.

### BACKGROUND OF THE INVENTION

Barrier food wraps comprised of polypropylene and polyethylene are widely used and well known. The purpose of these food wraps is for short-term storage and preservation of perishable food items. Perishable food items deteriorate through exposure to air and moisture, which results in proliferation of bacterial colonies resulting in contamination and rotting of food products.

Polypropylene based food wraps have excellent structural and mechanical properties and provide an efficient barrier to moisture. However, oxygen permeates through polypropylene and polyethylene based polymeric food wraps. This results in a short shelf life for foods wrapped therein.

To address the problem of oxygen permeation, multi-layer food wraps including a thin metal film layer were developed. Many of these food wraps employ a thin layer of aluminum film serving as a functional oxygen barrier. For reasons of cost and of mechanical performance of the film, the metallic layer has to be very thin. It is known to use vacuum deposition on a pre-formed film substrate as the technology for creating a thin layer of aluminum. Prior art barrier food wraps are known to bond a polypropylene film layer to a vacuum deposition aluminum layer. However, these food wraps have the drawback of having poor adhesion of the polypropylene layer to the vacuum deposited aluminum layer. This leads to an unacceptable performance of these food wraps in acting as a barrier to oxygen.

For example, U.S. Pat. No. 6,503,635 discloses a multi-layer film for the purposes of providing a barrier to oxygen and moisture. The film comprises a thin metal layer bound to a polymeric metallizable layer that comprises either a blend of syndiotactic polypropylene and a propylene-butylene-1 copolymer or a blend of syndiotactic polypropylene and maleic anhydride grafted syndiotactic polypropylene. The film also includes an additional polypropylene layer and one or more other layers. This film has the disadvantage of non-uniform and variable adhesion of the metallizable layer to the thin metal layer. This results in an imperfect seal between the metal layer and the metallizable polypropylene layer and in the possibility of a small amount of oxygen permeating through the film.

Polypropylene binds poorly to metals because polypropylene is a non-reactive polymer that has little affinity towards metals such as aluminum. In order to improve the binding of polypropylene to aluminum, it is necessary to provide polar functional groups near the interface of the polypropylene and the aluminum. One of the most efficient and functional groups at forming either strong polar-interactions or covalent bonds with a metallic aluminum surface is the anhydride functionality. Anhydride groups can be introduced in two ways. The first is by co-polymerization of propylene with maleic anhydride to form an anhydride modified polypropylene copolymer. The second method is the grafting of the maleic anhydride monomer onto a polypropylene backbone in the melt during extrusion of polypropylene in the presence of peroxides as radical initiators. Maleic anhydride grafting is a more economical and versatile way of introducing maleic anhydride functionality into the polypropylene matrix. This grafting is disadvantageous in that grafting high levels of maleic anhydride onto polypropylene during melt extrusion results in the polymer chain being cut into smaller segments. This results in a maleic anhydride modified polypropylene having lower molecular weight and lower viscosity than the starting polymer. The result is that the highly grafted polypropylene is not suitable to direct co-extrusion. The attempted solution to this problem in the past has been to blend the grafted polypropylene in a high molecular weight and high viscosity polypropylene based resin to form a blend of acceptable functionality for adhesion and a suitable rheology for extrusion. This has helped somewhat to address the problem but has still resulted in inconsistent and non-uniform adhesion of the polypropylene layer to the metal layer.

There is therefore a need for a polypropylene based film that has improved adhesion to thin vacuum deposited aluminum. There is a need for such a polypropylene based film that is grafted with maleic anhydride that has strong adhesion and acceptable rheology for co-extrusion with a vacuum deposited aluminum layer.

The disclosures of all patents/applications referenced herein are incorporated herein by reference.

### SUMMARY OF THE INVENTION

The present invention provides a metallizable alkene or olefin polymer composition. The composition results from the blending of a modifier with an alkene or olefin polymer composition. The modifier is selected from the group consisting of: a maleic anhydride grafted ethylene copolymer, an ethylene copolymer containing acid monomers and/or ester monomers, an acid-grafted propylene copolymer, and a maleic anhydride grafted blend of a propylene copolymer with an ethylene copolymer. The resultant polymeric composition adheres surprisingly well to metal films and particularly well to aluminum film. The resultant composition also has unexpectedly favourable rheology properties making the composition efficient to use in co-extrusion processes. The resultant maleic anhydride grafted polymeric composition adheres surprisingly well to metal films and particularly well to aluminum film. The resultant composition also has unexpectedly favourable rheology properties malting the maleic anhydride grafted polymeric composition efficient to use in co-extrusion processes.

The present invention also provides barrier food wrap for protecting against permeation of moisture and oxygen. The wrap has a metallized propylene polymer layer that is attached to a metal film layer. The metallized propylene polymer layer is a blend of an alkene or olefin polymer, and a modifier selected from the group consisting of: a maleic anhydride grafted ethylene copolymer, an ethylene copolymer containing acid monomers and/or ester monomers, an acid-grafted propylene copolymer, and a maleic anhydride grafted blend of a propylene copolymer with an ethylene copolymer. The alkene or olefin polymer preferably comprises propylene monomers. The metal film is preferably a vacuum deposited aluminum layer. The wrap preferably has an additional polypropylene barrier layer and a heat sealable layer.

The present invention also includes a method of preparing maleic anhydride grafted propylene polymer compositions. The method involves blending an alkene or olefin polymer, with a modifier selected from the group consisting of: a maleic anhydride grafted ethylene copolymer, an ethylene copolymer containing acid monomers and/or ester monomers, an acid-grafted propylene copolymer, and a maleic anhydride grafted blend of a propylene copolymer with an ethylene copolymer.

According to one aspect of the present invention, there is provided a polymeric composition comprising a blend of: an alkene polymer, and a modifier selected from the group consisting of: a maleic anhydride grafted ethylene copolymer, an ethylene copolymer containing acid monomers and/or ester monomers, an acid-grafted propylene copolymer, and a maleic anhydride grafted blend of a propylene copolymer with an ethylene copolymer. The alkene or olefin polymer preferably comprises propylene monomers.

According to another aspect of the invention, there is provided a packaging film including: a first layer comprising a metal film; and a second layer on the first layer and comprising a polymeric composition comprising a blend of: an alkene polymer, and a modifier selected from the group consisting of: a maleic anhydride grafted ethylene copolymer, an ethylene copolymer containing acid monomers and/or ester monomers, an acid-grafted propylene copolymer, and a maleic anhydride grafted blend of a propylene copolymer with an ethylene copolymer.

According to another aspect of the invention, there is provided a method of preparing a metallizable polymeric composition comprising the following steps:

a. providing a polymeric matrix including an alkene polymer preferably having propylene monomers;

b. providing a modifier selected from the group consisting of: a maleic anhydride grafted ethylene copolymer, an ethylene copolymer containing acid monomers and/or ester monomers, an acid-grafted propylene copolymer, and a maleic anhydride grafted blend of a propylene copolymer with an ethylene copolymer; and

c. blending the modifier with the polymeric matrix.

Numerous other objectives, advantages and features of the process will also become apparent to the person skilled in the art upon reading the detailed description of the preferred embodiments, the examples and the claims.

### BRIEF DESCRIPTION OF THE DRAWINGS

The preferred embodiments of the present invention will be described with reference to the accompanying drawings in which like numerals refer to the same parts in the several views and in which:

FIG. 1 is a schematic cross-section of a preferred embodiment of multi-layer barrier wrap of the present invention

### DETAILED DESCRIPTION OF THE PREFERRED EMBODIMENTS

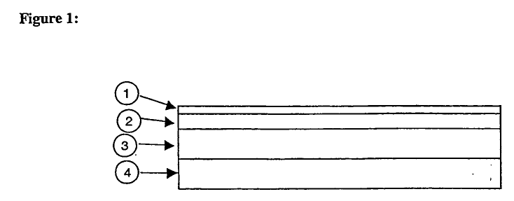

The preferred embodiments of the present invention will now be described with reference to the accompanying FIG. 1.

The present invention provides a metallizable polymeric composition that binds effectively to a thin film of metal. The term “metallizable” as used herein means capable of effectively binding to a metal. The polymeric composition comprises an alkene polymer having propylene monomers. Preferably, the alkene polymer is polypropylene. Most preferably the alkene polymer is a co-polymer of propylene and ethylene having low levels of the ethylene monomer of between approximately 1% to approximately 6% by weight. Other examples are a copolymer of propylene with butene and a terpolymer of propylene, ethylene and butene. Additional examples of modified-polypropylene compositions that produce the intended effect of improving adhesion of polypropylene to aluminum are presented in Tables 6 to 9 below.

In order for the alkene polymer to bind effectively to the metal film, it is necessary to graft functional groups onto the backbone of the alkene polymer. According the present invention, the alkene polymer is blended with a modifier selected from the group consisting of: a maleic anhydride grafted ethylene copolymer, an ethylene copolymer containing acid monomers and/or ester monomers, an acid-grafted propylene copolymer, and a maleic anhydride grafted blend of a propylene copolymer with an ethylene copolymer. Preferably, maleic anhydride functionality is grafted on either Linear Low Density Polyethylene (LLDPE) produced with metallocene as the polymerization catalyst or Very Low Density Polyethylene (VLDPE) produced with metallocene as the polymerization catalyst These will hereafter be referred to as mLLDPE and mVLDPE. These grafts are also prepared by melt extrusion of the mVLDPE or mLLDPE in the presence of both a radical initiator and Maleic Anhydride, in a twin-screw extruder.

According to a preferred embodiment of the present invention, the alkene polymer is blended in a high molecular weight (high viscosity) polypropylene base resin to form a blend of acceptable functionality for adhesion to the metal and of suitable rheology for extrusion.

The present invention provides the unexpected result that a polymeric composition obtained from blending a modifier as described above with a base resin containing a propylene polymer such as polypropylene provides superior adhesion of the polymeric composition to the metal than do blends of the same polypropylene base resin with a conventional maleic anhydride grafted polypropylene. The polymeric composition of the present invention also maintains excellent rheology for co-extrusion processes. The polymeric composition preferably has a melt index from 1 to 20. This result is unexpected because it is known in the art that polypropylene and polyethylene are not compatible, and usually form blends of poor morphology. This unexpected result is unique to the modifiers described herein since poorer adhesion to metals is obtained through the use of maleic anhydride graft sources made from conventional LLDPE's where the polymerization catalyst is a conventional one such as a Ziegler-Natta catalyst.

The alkene polymer preferably comprises propylene monomers. Most preferably, the alkene polymer is polypropylene, a copolymer of propylene and ethylene, a copolymer of propylene with butene or a terpolymer of propylene, ethylene and butene.

The modifier useful in the present invention is selected from the group consisting of:

a. a maleic anhydride grafted ethylene copolymer, which is preferably selected from the group consisting of: maleic anhydride grafted metallocene very low density polyethylene, maleic anhydride grafted metallocene linear low density polyethylene, and a maleic anhydride grafted linear low density polyethylene made from a Ziegler-Natta catalyst,

b. an ethylene copolymer containing acid monomers and/or ester monomers, in which the acid monomers are preferably acrylic acid or methacrylic acid, and the ester monomers are preferably alkyl esters of acrylic acid, alkyl acrylates, alkyl esters of methacrylic acid, alkyl methacrylates, glycidylmethacrylate, or vinyl acetate,

c. an acid-grafted propylene copolymer, preferably acrylic acid grafted polypropylene, and

d. a maleic anhydride grafted blend of a propylene copolymer with an ethylene copolymer, preferably the polypropylene is a propylene copolymer with ethylene and the ethylene copolymer is a metallocene very low density polyethylene.

The present invention also provides a multilayer barrier food wrap that includes a layer comprising the polymeric composition described above as a metallizable layer. A preferred embodiment of the barrier food wrap is shown schematically in FIG. 1. Preferably, the barrier food wrap has four layers.

A first layer 1 of the barrier food wrap of FIG. 1 is a thin metal film. Preferably, this layer is formed of vacuum deposited aluminum. Other acceptable metals include copper, silver, chromium, gold and mixtures thereof. This layer functions as a barrier to oxygen and moisture.

The second layer 2 is the metallizable polymeric composition of the present invention. This layer is comprised of the metallizable polymeric composition described above that results from blending propylene containing alkene polymer with a modifier. Preferably the thickness of this layer is 10-25μ.

A third layer 3 is fused to the second layer 2. The third layer 3 preferably comprises polypropylene and functions as a barrier. Preferably the thickness of this layer is 10-25μ.

A fourth layer 4 is fused to the third layer 3. The fourth layer 4 is a heat sealable polypropylene layer. The materials of construction may alternatively be a co-polypropylene blended with an elastomer, or a polypropylene/polyethylene copolymer with sufficient ethylene comonomer to provide elastomeric behaviour, or a copolymer of propylene/butene-1, or a homopolymer of butene-1.

The packaging film according to the present invention may be made by co-extruding the first layer 1 and the second layer 2. The third layer 3 may also be co-extruded to the second layer, and the fourth layer may be co-extruded to the third layer.

A further aspect of the present invention is a method of preparing a metallizable polymeric composition. The method comprises the steps of: (a) providing a polymeric matrix comprising an alkene polymer; (b) providing a modifier selected from the group consisting of: a maleic anhydride grafted ethylene copolymer, an ethylene copolymer containing acid monomers and/or ester monomers, an acid-grafted propylene copolymer, and a maleic anhydride grafted blend of a propylene copolymer with an ethylene copolymer; and (c) blending the modifier with the polymeric matrix.

Preferably, the polymeric matrix and the modifier are both resins, or the polymeric matrix is a resin and the modifier is a concentrate of maleic anhydride and the concentrate is blended into the resin. The blending step is carried out in the presence of peroxides as radical initiators. The method may further comprise the step of adding a layer of aluminum on a surface of the polymeric composition, in which the aluminum is vacuum deposited onto the surface.

In order to modify or enhance certain properties of the multi-layer films of the present invention, it is possible for one or more of the layers to contain appropriate additives. Examples of acceptable additives include, anti-blocks, anti-static agents, coefficient of friction (COF) modifiers, processing aids, colorants and clarifiers. There are other additives known in the art that would also be acceptable.

An exposed layer of the present multi-layer film could be surface-treated to make the film receptive to printing inks, adhesives and coatings. These surface-treated layers may subsequently laminated onto other films or surfaces. The surface treatment can be carried out by any method known in the art such as corona discharge treatment or flame treatment.

Optionally, a coating may be applied to one or both of the exposed surfaces of outermost layers of a film to facilitate lamination. Prior to application of the coating material, the film may be surface treated or may be primed with a primer layer. Appropriate coatings contemplated include acrylic coatings. and PVDC coatings. A vinyl alcohol polymer may also be used as a coating composition.

Appropriate primer materials are poly(ethyleneimine), epoxy primers, and the like.

The outer surface of the multi-layer film may be treated as noted above to increase its surface energy and therefore insure that the coating layer will be strongly adherent thereto thereby reducing the possibility of the coating peeling or being stripped from the film. This treatment can be accomplished employing known techniques, such as, for example, film chlorination, i.e., exposure of the film surface to aqueous chlorine, treatment with oxidizing agents such as chromic acid, hot air or steam treatment, and the like. Although any of these techniques are effectively employed to pre-treat the film surface, a particularly desirable method of treatment is the so-called corona treatment method, which comprises exposing the film surface to a high voltage corona discharge while passing the film between a pair of spaced electrodes. After corona treatment of the film surface, the coating composition is then applied thereto.

Treated or untreated surfaces may be laminated together with a suitable adhesive, e.g., a hot melt adhesive such as low density polyethylene, ethylene-methacrylate copolymer, water-based adhesives such as polyvinylidene chloride latex, and the like.

The following examples establish the superior performance of the modifiers as described herein, and in particular, maleic anhydride grafted mLLDPE and mVLDPE, as graft sources in the formulation of a metallizable polymeric compositions comprising propylene. The use of the modifiers herein has also the additional advantage of providing superior mechanical properties for extrusion of the metallizable polypropylene layer. These resultant metallizable polymeric compositions have a higher melt viscosity, and provide a better viscosity match with materials that may form adjacent layers in films useful as a barrier food wraps.

### EXAMPLES

### Preparation of Metallized Polymeric Composition

Metallized polymeric composition were prepared as follows:

Square film coupons measuring 4 inches×4 inches were treated in a vacuum metallization chamber. The vacuum system was pumped down to 2×10⁻⁵ torr and the aluminum was heated such as to deposit on the film surface at a rate of 5 Angstroms per second to a thickness of 200 Angstroms. The thickness of the deposited aluminum layer was determined by either surface resistivity or light transmission, using preestablished correlations.

### Preparation of Multi Layer Metallized Polymeric Films

Films for adhesion performance evaluation were cast on a pilot-scale co-extrusion line equipped with three extruders, a Killion 8″ wide cast roll unit and a Cloeren 8″ (5-vane) cast film die configured to run with three resin feeds:

Die configuration: AABBC selector plug.

A: 1¾″ Diameter NRM Single Screw Extruder, feeding the material chosen for the inner layer.

B: 1.0″ Diameter Davis Standard Single Screw, feeding the material selected as core layer.

C: 1¼″ Diameter Wayne Single Screw Extruder, feeding the modified-PP composition.

Selector Plug: AA-BB-C

Total Line Speed: 20 fpm

Total Film Thickness: 3 mil

The temperatures used are shown in Table 1 below.

TABLE 1

| | TEMPERATURES (° C.) | | | | | | | | |
|---|---|---|---|---|---|---|---|---|---|
| | | | | | | | TRANS- | | |
| EXTRU- | ZONE | ZONE | ZONE | ZONE | ADAP- | COUP- | FER | | |
| DER | 1 | 2 | 3 | 4 | TOR | LING | LINE | Tmelt | RPM |
| A | 180 | 210 | 220 | — | 220 | 220 | 220 | 227 | 6.1 |
| B | 180 | 210 | 220 | 220 | 227 | 220 | 220 | 227 | 32.9 |
| C | 180 | 220 | 221 | 220 | 220 | 220 | 220 | 223 | 17 |

Cloeren Die - Temperatures (° C.)

| BACK | LEFT HAND FLANGE | FRONT | RIGHT HAND FLANGE |
|---|---|---|---|
| 220 | 224 | 218 | 223 |

The 3-layer cast films were subsequently Corona treated. Corona-treater parameters were set to obtain a final surface energy of 41 dynes/cm², at a line speed of 100 ft/min.

### Adhesion Test Used

The adhesion of the polymeric metallizable layer to the vacuum deposited film was measured using the following method. The vacuum metallized coupons were first heat-sealed with a NUCREL® 903 film, over the Aluminum layer, using a Sencorp Systems heat-sealer that has 2×1 inch wide separately heated sealing bars. The NUCREL® film was sealed under 40 psi/135° C. for a dell time of 0.5 sec. Peel was initiated at the modified-PP/Aluminum interface, and peel force was then measured using an Instron mechanical tester, under ambient conditions, at a jaw speed of 12 inch/min. Results were reported in lb.ft/in.

### Examples Made

Metallizable polypropylene compositions were first blended by extrusion using a 25 mm Berstorff twin-screw extruder. Five different polypropylene resins were modified with three different maleic anhydride grafted polyolefins, used as source of maleic anhydride graft. The polypropylene (PP) base resins were modified at two different graft levels.

TABLE 2

| BASE | | | |
|---|---|---|---|
| RESIN | TYPE | MI (230° C., 2.16 Kg) | Tₘ (° C.) |
| A | co-PP | 1.9 | 148 |
| B | co-PP | 5 | 134 |
| C | co-PP | 4.6 | 134 |
| D | IMPACT MODIFIED | 1.4 | 125 |
| E | homo-PP | 3.4 | 160 |

TABLE 3

| | BASE | % Maleic | MI (190° C., |
|---|---|---|---|
| MODIFIER | POLYMER | Anhydride | 2.16 Kg) |
| F | co-PP | 1.40 | 450 |
| G | mLLDPE | 0.80 | 1.9 |

Composition of modified PP used as metalliable PP layer in 3-layer constructions.

TABLE 4

| | |
|---|---|
| Base co-PP | Modifier |

| MODIFIED-PP | TYPE | % | TYPE | % | % MAN-g |
|---|---|---|---|---|---|
| 1 | A | 92 | F | 8 | 0.11 |
| 2 | A | 80 | F | 20 | 0.28 |
| 3 | B | 92 | F | 8 | 0.11 |
| 4 | B | 80 | F | 20 | 0.28 |
| 5 | C | 92 | F | 8 | 0.11 |
| 6 | C | 80 | F | 20 | 0.28 |
| 7 | D | 88 | H | 15 | 0.12 |
| 8 | D | 65 | H | 35 | 0.28 |
| 9 | E | 85 | G | 15 | 0.12 |
| 10 | E | 65 | G | 35 | 0.28 |
| 11 | A | 85 | G | 15 | 0.12 |
| 12 | A | 65 | G | 35 | 0.28 |
| 13 | B | 85 | G | 15 | 0.10 |
| 14 | B | 65 | G | 35 | 0.30 |
| 15 | C | 85 | G | 15 | 0.12 |
| 16 | C | 65 | G | 35 | 0.28 |

Each modified PP composition was co-extruded, using a 8″ co-extrusion casting line, in a 3-layer film, using Dow's 5D98 homo-PP as core layer, and Dow's 7C06 impact-modified PP as backing layer. Each film construction was first Corona-treated to approx. 41 dynes/cm², and then was metallized with Aluminum (approx. 200 nm thick layer). Adhesion of the metallizable layer to the deposited Aluminum was evaluated after heat sealing, using a double-bar heat sealer, the aluminum top layer to a Nucrel film. One-inch wide strips were cut out of the heat-sealed substrates, peel was initiated manually and peel strength, at the aluminium/modified-PP interface, was measured by Instron. Adhesion performance within metallized 3-layer PP film construction is shown in TABLE 5 under peel strength in g/in peel force. Minimum “acceptable” for full functionality Peel Strength for full functionality is 130 g/in, based on existing commercial film.

TABLE 5

| | MODIFIED | CORE | INNER | PEEL FORCE |
|---|---|---|---|---|
| EXAMPLE | PP | LAYER | LAYER | (g/in) |
| I | 1 | 5D98 | 7C06 | 72 |
| II | 2 | 5D98 | 7C06 | 84 |
| III | 3 | 5D98 | 7C06 | 74 |
| IV | 4 | 5D98 | 7C06 | 75 |
| V | 5 | 5D98 | 7C06 | 74 |
| VI | 6 | 5D98 | 7C06 | 58 |
| VII | 7 | 5D98 | 7C06 | 54 |
| VIII | 8 | 5D98 | 7C06 | 48 |
| IX | 9 | 5D98 | 7C06 | 55 |
| X | 10 | 5D98 | 7C06 | 106 |
| XI | 11 | 5D98 | 7C06 | 58 |
| XII | 12 | 5D98 | 7C06 | 175 |
| XIII | 13 | 5D98 | 7C06 | 247 |
| XIV | 14 | 5D98 | 7C06 | 240 |
| XV | 15 | 5D98 | 7C06 | 95 |
| XVI | 16 | 5D98 | 7C06 | 159 |

Examples XII, XIII, XIV, XVI display superior performance. They correspond respectively to modified-polypropylene formulations 12, 13, 14, 16 (see TABLE 4). Thus, only formulations based on mLLDPE meet the target performance, i.e. those formulations based on modifier G (see TABLE 3). Compositions based on maleic anhydride grafted polypropylene (modified-PP compositions A-F) show performance inferior to the 130 g/in standard, furthermore, the co-polypropylene with the highest ethylene comonomer content (lower Tₘ134° C., Examples XIII and XIV) perform best even at the lower graft level, which is an advantage in terms of formulation for the lowest cost.

Comparison of Examples VII and VIII to Examples I to VI highlights the inferior performance of impact-modified polypropylene in comparison to co-polypropylene.

Comparison of Examples IX and X to Examples XI to XVI clearly demonstrate the superior performance of co-polypropylene over homo-polypropylene.

TABLE 6
ADDITIONAL BASE RESINS

| BASE | | | |
|---|---|---|---|
| RESIN | TYPE | MI (190° C./2.16 Kg) | Tm (° C.) |
| H | P/B CoPolymer⁽¹⁾ | 2 | |
| I | P/E/B Terpolymer⁽²⁾ | 6-8 | 138 |

⁽¹⁾Mitsui's TAFMER XR107L
⁽²⁾Chisso's NOVATEC PP FW4BM

TABLE 7
ADDITIONAL “OTHER” MODIFIERS

| | | | | | MI |
|---|---|---|---|---|---|
| MODI- | BASE | % | % | % | (190° C./ |
| FIER | POLYMER | MAN-g | ACID | ESTER | 2.16 Kg) |
| J | E/MAA⁽¹⁾ | N/A | 9 | N/A | 3 |
| K | E/VA/MAH⁽²⁾ | — | N/A | — | 2 |
| L | AA-g-PP⁽³⁾ | N/A | 6 | — | ~2 |
| M | E/VA/MAA⁽⁴⁾ | N/A | 1.5 | 25 | 6 |
| N | E/AA⁽⁵⁾ | N/A | 9.7 | | 5 |
| O | E/Octene⁽⁶⁾ | 0.9 | N/A | N/A | 1.5 |
| P | E/Octene⁽⁷⁾ | 1.2 | N/A | N/A | 7 |
| Q | P/B CoPolymer⁽⁸⁾ | 2.3 | N/A | N/A | 5 |
| R | mVLDPE/coPP | 1.96 | N/A | N/A | 62 |
| | Co-Graft⁽⁹⁾ | | | | |

⁽¹⁾NUCREL 903, %9 Methacrylic Acid
⁽²⁾Atofina's OREVAC 9314,
⁽³⁾Crompton's POLYBOND 1002,
⁽⁴⁾ELVAX 4355, %
⁽⁵⁾Dow's PRIMACOR 1430
⁽⁶⁾FUSABOND 226D
⁽⁷⁾FUSABOND 528D
⁽⁸⁾DDE's ENGAGE ENR 7447, 2.3% MAN-g
⁽⁹⁾Dow's 6D81 coPP/ENGAGE 8411 mVLDPE (80/20) co-Graft, 1.96% MAN-g

TABLE 8
NEW <<MODIFIED PP>> LAYERS

| MODIFIED | BASE PP | | MODIFIER | | |
|---|---|---|---|---|---|
| PP | TYPE | % | TYPE | % | % FUNCTIONALITY |
| 17 | C | 65 | J | 35 | 3.2 |
| 18 | B | 90 | K | 10 | — |
| 19 | B | 65 | L | 35 | 2.1 |
| 20 | B | 90 | M | 10 | 2.5 |
| 21 | B | 65 | M | 35 | 8.8 |
| 22 | B | 90 | N | 10 | 1 |
| 23 | B | 64 | O | 36 | 0.32 |
| 24 | B | 73 | P | 27 | 0.32 |
| 25 | H | 85 | G | 15 | 0.12 |
| 26 | B | 85 | G | 15 | 0.12 |
| 27 | B | 97 | Q | 3 | 0.069 |
| 28 | B | 96.7 | R | 3.3 | 0.065 |
| 29 | B | 85 | M | 15 | 3.75 |
| 30 | I | 84 | G | 16 | 0.128 |

TABLE 9
ADDITIONAL EXAMPLES OF MODIFIED
PP IN cPP STRUCTURES

| | MODIFIED | CORE | INNER | PEEL FORCE |
|---|---|---|---|---|
| EXAMPLE | PP | LAYER | LAYER | (g/in) |
| XVII | 17 | 5D98 | 7C06 | 194 |
| XVIII | 18 | 5D98 | 7C06 | 174 |
| XIX | 19 | 5D98 | 7C06 | 142 |
| XX | 20 | 5D98 | 7C06 | 225 |
| XXI | 21 | 5D98 | 7C06 | 326 |
| XXII | 22 | 5D98 | 7C06 | 194 |
| XXIII | 23 | 5D98 | 7C06 | 131 |
| XXIV | 24 | 5D98 | 7C06 | 175 |
| XXV | 25 | 5D98 | 7C06 | 142 |
| XXVI | 26 | 5D98 | 7C06 | 153 |
| XXVII | 27 | 5D98 | 7C06 | 224 |
| XXVIII | 28 | 5D98 | 6D20 | 220 |
| XXIX | 29 | 5D98 | 6D20 | 144 |
| XXX | 30 | 5D98 | 6D20 | 379 |

The results in Tables 6 to 9 show additional modifiers that can be successfully used in addition to maleic anhydride grafted LLDPE or VLDPE produced with metallocene as the polymerization catalyst. Table 6 provides two additional examples of base resins that can be modified with maleic anhydride grafted mVLDPE (see modified PP 25 and 30 in Table 8 and examples XXV and XXX in Table 9). Adhesion to vacuum deposited Aluminum can also be improved by modifiers consisting of:

a. ethylene/methacrylic acid copolymers (modifier J in Table 7, modified PP 17 in Table 8 and example XVII in Table 9);

b. ethylene/vinyl acetate/maleic anhydride terpolymer (modifier K in Table 7, modified PP 18 in Table 8 and example XVIII in Table 9);

c. acrylic acid grafted PP (modifier L in Table 7, modified PP 19 in Table 8 and example XIX in Table 9);

d. ethylene/vinyl acetate/methacrylic acid terpolymer (modifier M in Table 7, modified PP's 20, 21, 29 in Table 8 and examples XX, XXI and XXX in Table 9);

e. ethylene/acrylic acid copolymers (modifier N in Table 7, modified PP 22 in Table 8 and example XXII in Table 9);

f. maleic anhydride grafted ethylene/octene mLLDPE (higher density) (modifier O in Table 7, modified PP 23 in Table 8 and example XXIII in Table 9);

g. maleic anhydride grafted ethylene/octene LLDPE (Ziegler-Natta) (modifier P in Table 7, modified PP 24 in Table 8 and example XXIV in Table 9);

h. maleic anhydride grafted ethylene/butene mVLDPE (modifier Q in Table 7, modified PP 27 and example XXVII in Table 9); and

i. maleic anhydride co-graft of a 80/20 blend of a copolymer PP with mVLDPE (modifier R in Table 7, modified PP 28 in Table 8 and example XXVIII in Table 9).

Although the present invention has been shown and described with respect to its preferred embodiments and in the examples, it will be understood by those skilled in the art that other changes, modifications, additions and omissions may be made without departing from the substance and the scope of the present invention as defined by the attached claims.

1. A polymeric composition comprising a blend of:
a) an alkene polymer comprising propylene monomers; and
b) a modifier selected from the group consisting of: maleic anhydride grafted metallocene very low density polyethylene, maleic anhydride grafted metallocene linear low density polyethylene, and a maleic anhydride grafted linear low density polyethylene made from a Ziegler-Natta catalyst.

2. (canceled)

3. The polymeric composition according to claim 1 wherein the alkene polymer is polypropylene.

4. The polymeric composition according to claim 1 wherein the alkene polymer is a copolymer of propylene and ethylene.

5. The polymeric composition of claim 1 wherein the alkene polymer is a copolymer of propylene with butene.

6-12. (canceled)

13. A packaging film including:
(a) a first layer comprising a metal film; and
(b) a second layer on the first layer and comprising a polymeric composition comprising a blend of:
i) an alkene polymer comprising propylene monomers; and
ii) a modifier selected from the group consisting of: maleic anhydride grafted metallocene very low density polyethylene, maleic anhydride grafted metallocene linear low density polyethylene, and a maleic anhydride grafted linear low density polyethylene made from a Ziegler-Natta catalyst.

14. (canceled)

15. The packaging film according to claim 13 wherein the alkene polymer is polypropylene.

16. The packaging film according to claim 13 wherein the alkene polymer is a copolymer of propylene and ethylene.

17. The packaging film of claim 13 wherein the alkene polymer is a copolymer of propylene with butene.

18-24. (canceled)

25. The packaging film according to claim 13 wherein the metal is aluminum.

26. (canceled)

27. The packaging film according to claim 13 wherein the first layer and the second layer are co-extruded.

28-30. (canceled)

31. A process for preparing a metallizable polymeric composition comprising the steps of:
a) providing a base resin comprising an alkene polymer wherein the alkene polymer comprises propylene monomers;
b) providing a modifier selected from the group consisting of: maleic anhydride grafted metallocene very low density polyethylene, maleic anhydride grafted metallocene linear low density polyethylene, and a maleic anhydride grafted linear low density polyethylene made from a Ziegler-Natta catalyst; and
c) blending the modifier with the base resin.

32-44. (canceled)

45. The process according to claim 31 wherein the blending step is carried out in the presence of peroxides as radical initiators.

46-47. (canceled)

48. A process for preparing a packaging film comprising the steps of:
a) providing a base resin comprising an alkene polymer, wherein the alkene polymer comprises propylene monomers;
b) providing a modifier selected from the group consisting of: maleic anhydride grafted metallocene very low density polyethylene, maleic anhydride grafted metallocene linear low density polyethylene, and a maleic anhydride grafted linear low density polyethylene made from a Ziegler-Natta catalyst;
c) blending the modifier with the base resin to form a polymeric composition; and
d) applying a layer of aluminum on a surface of the polymeric composition to form the packaging film.

49. The process according to claim 48 wherein the aluminum is vacuum deposited onto the surface of the polymeric composition.
